(19) United States
(12) Patent Application Publication
(10) Pub. No.: US 2005/0257572 A1
(43) Pub. Date: Nov. 24, 2005

(54) Device and method for the piece-wise or batch-wise refining of pieces of a substrate, in particular a textile substrate, under high pressure

(76) Inventor: Ludo Jean Maria Mathilde Van Schepdael, Herent (BE)

Correspondence Address: HOFFMANN & BARON, LLP, 6900 JERICHO TURNPIKE, SYOSSET, NY, 11791, US

(21) Appl. No.: 10/521,906

(22) PCT Filed: Jul. 11, 2003
(86) PCT No.: PCT/NL03/00512

§ 371 Date: Jan. 20, 2005

(51) Int. Cl. B08B 3/12

(52) U.S. Cl. 68/3 R

(57) ABSTRACT

Device for the piece-wise or batch-wise refining of pieces of a substrate, in particular a textile substrate, under high pressure with a treatment medium, comprising: a substantially cylindrical pressure vessel (1), which is provided with a closable feed aperture (4) for placing the pieces of substrate in the pressure vessel (1); a pipe system (7) for feeding a treatment medium to and discharging it from the pressure vessel (1) under high pressure during treatment. The cylindrical pressure vessel is provided on at least one of the two end faces with an aperture that is closable by a lid (2, 3), which aperture forms the feed aperture (4). The device comprises retaining means for keeping the lid (2, 3) in place in a sealing manner during treatment, and the retaining means comprise a bounding frame (10) that is circumferentially closed, with two interconnected end pieces (11, 12) situated at a distance from each other, which end pieces in a closed position can be slid over the pressure vessel (1) and thereby retain the end faces of the pressure vessel (1) in the axial direction.

The invention relates to a device for the piece-wise or batch-wise refining of pieces of a substrate, for instance a textile substrate, under high pressure with a treatment medium according to the preamble of claim 1.

Such a device is known, for example from EP-1.152.081-A1, which discloses a device for dyeing a textile substrate. The device comprises a dye vessel, in which a textile substrate can be placed at the beginning of each cycle. To this end, the dye vessel is provided with a feed aperture that is to be closed by a cover element. The dye vessel forms part of a main pipe system, in which a fluid containing dyestuff is circulated under high pressure. The pressure applied during the dyeing operation is at least so high that at the desired treatment temperature the fluid is in a supercritical or near critical state. Normally, the pressure lies in the range of 5×10⁶-5×10⁷ pascal (50-500 bar).

A disadvantage in the case of this known device is that the dye vessel has to be of a heavy construction, in order to be able to withstand the high working pressures. This makes the device expensive to manufacture. It has to be possible to open the cover element and close it again after each treatment cycle. Very heavy closing means, such as large bolts and nuts, are needed in order to be able to keep the cover element in place in a sealing manner at the high working pressures. The cover element itself also has to be of a very thick-walled and heavy construction. The lid in this case generally rests with an axial sealing ring against a flange of the pressure vessel. In order to be able to make the axial seal secure, the retaining means must be brought under high tension. This is usually a time-consuming and difficult operation, as is removing of the closing means again after the treatment cycle has been completed.

The object of the present invention is to at least partially overcome the abovementioned disadvantages, or to provide a usable alternative. In particular, the object of the invention is to provide a treatment device of the abovementioned type that is cheap to manufacture and is characterized by a relatively low weight.

This object is achieved according to the present invention by a device according to claim 1. In this case a bounding frame that is closed around its circumference is provided with two interconnected end pieces situated at a distance from each other. The bounding frame and the pressure vessel can be slid into each other, in which case the end faces of the pressure vessel are retained in the axial direction by the two end pieces of the bounding frame. Owing to the fact that a feed aperture that can be closed by a lid is provided on at least one of the two end faces of the pressure vessel, the lid is advantageously retained directly by the bounding frame in the axial direction. The axial pressure forces acting upon the lid are advantageously dissipated by the bounding frame, and therefore do not act upon the cylinder wall of the pressure vessel. The cylinder wall therefore only has to withstand the radial pressure forces acting upon it. As a result of this separation of axial and radial forces, the design of the pressure vessel walls becomes simpler. For example, in the case of vessel walls of composite materials, glass windings or carbon fibre windings over the end faces of the pressure vessel or with an axial component can be dispensed with, owing to the fact that only tangential cylinder wall windings are needed. A vessel having walls of composite materials has the advantage that the vessel can be given a better thermic isolation and a lower thermic inertia, which leads to a shorter cycle time, improved steering and control, and energy saving of the refining process.

During a treatment cycle a seal between the lid and the pressure vessel can remain very reliably secured. During the treatment cycle the bounding frame is placed under tensile stress substantially only in the axial direction. The bounding frame that is closed on all sides can consequently advantageously be of a relatively lightweight construction and, for example, comprise lightweight wound fibres. Owing to the fact that it is now possible to have the lid supported over a large part of its outer surface, the lid can also be of a relatively lightweight design. Sliding the pressure vessel and the bounding frame in or out of each other at the beginning and end of a treatment cycle is a simple operation, which can easily be automated. It has been found that the device according to the invention can be manufactured considerably more cheaply than is the case according to the prior art. For example, the costs of the assembly of pressure vessel, lid and bounding frame can be a factor of two to three times lower than for the assembly of pressure vessel, lid and retaining means according to the prior art. Considerable reductions in weight can also be achieved.

The device is intended for the piece-wise refining of pieces of a substrate under high pressure with a treatment medium. Refining in the context of the invention should be understood as meaning, inter alia, dyeing, washing, cleaning, de-greasing, or otherwise treating or pre-heating a substrate. The treatment medium is preferably formed by supercritical or near critical fluid, for example carbon dioxide, containing for example solid dye particles or cleaning particles.

In a particular embodiment the lid comprises a cylindrical wall part, which is intended to be placed in the cylindrical circumferential wall of the pressure vessel. At least one sealing ring is provided between this cylindrical wall part and an inner circumferential wall of the pressure vessel. The sealing ring in this case is designed to permit a slide of the lid in the axial direction relative to the pressure vessel. This advantageously means that a certain elongation of the bounding frame in the axial direction can be compensated for by a corresponding axial movement of the lid relative to the inner circumferential wall of the pressure vessel.

Further preferred embodiments of the invention are described in the subclaims.

The invention also relates to a method for the piece-wise or batch-wise refining of pieces of a substrate, for instance a textile substrate, under high pressure with a treatment medium according to claims 13-15, and to the use of a device according to claim 16.

The invention will be explained in greater detail with reference to the appended drawing, in which:

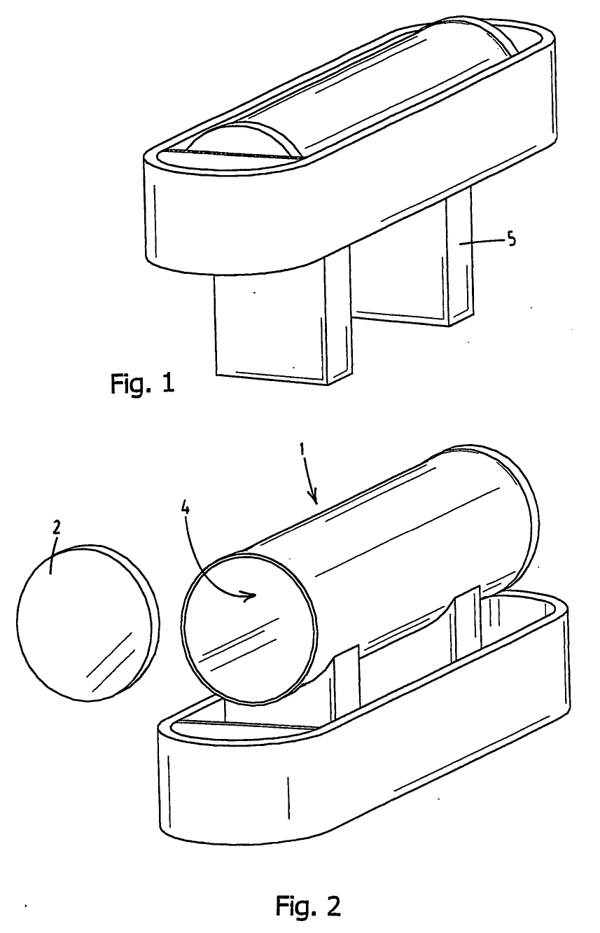

FIG. 1 is a diagrammatic view in perspective of an embodiment of the device according to the invention, with the bounding frame placed in a closed position;

FIG. 2 is a view according to FIG. 1, with a lowered bounding frame;

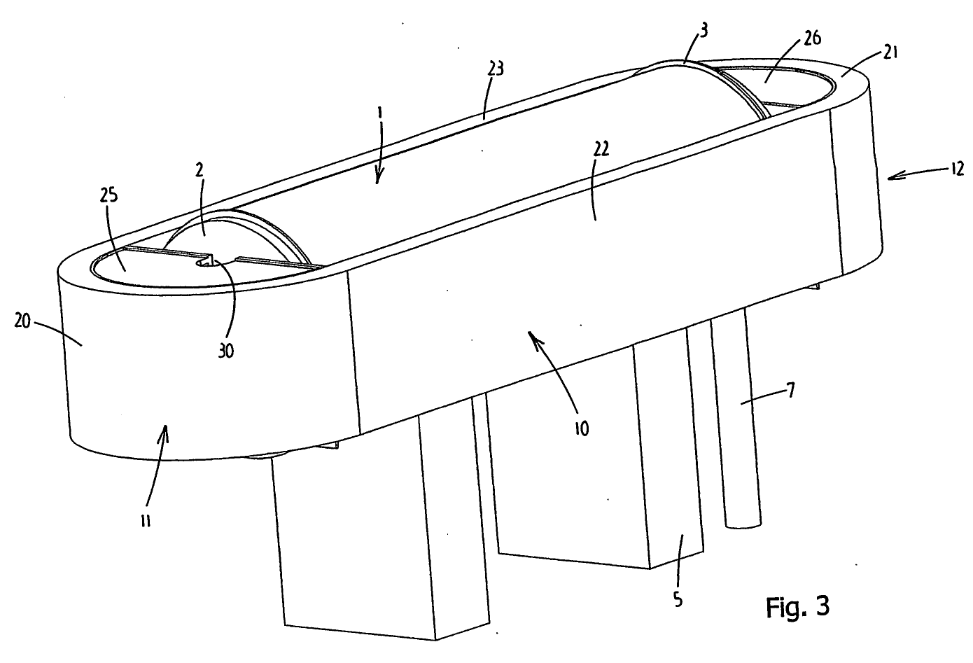

FIG. 3 is a more detailed view in perspective of FIG. 1;

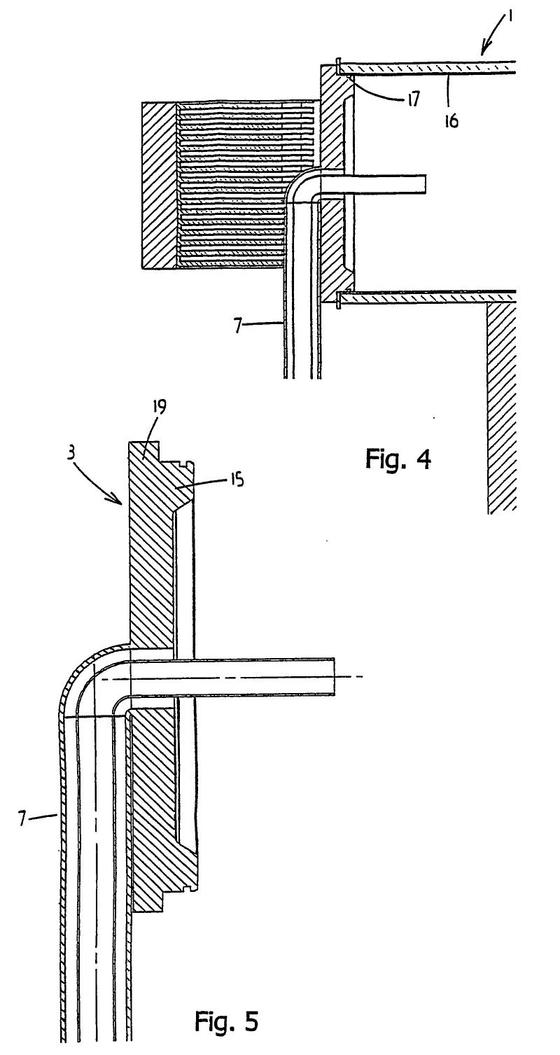

FIG. 4 is a view in longitudinal section of the right end face in FIG. 3; and

FIG. 5 is a view on an enlarged scale of the lid with pipe system from FIG. 4 opening into it.

The pressure vessel is indicated in its entirety by 1 in FIGS. 1-5. The pressure vessel 1 is of a cylindrical design and comprises a feed aperture 4 closable by a lid 2, 3 on both end faces. The pressure vessel 1 rests on two stands 5. Inside the pressure vessel 1 is a treatment chamber, in which one or more pieces of textile substrate is (are) to be placed at the beginning of a treatment cycle.

A pipe system 7, which opens into the pressure vessel 1, is provided. The pipe system 7 is intended for connection to feed means for feeding in and discharging a treatment medium, in particular supercritical or near critical fluid, under high pressure.

In order to be able to maintain a high pressure inside the pressure vessel 1 during the treatment, a bounding frame 10, comprising two interconnected end pieces 11, 12 situated at a distance from each other, is provided. The bounding frame 10 is closed allround and can be pushed over the pressure vessel 1. This is the closed position shown in FIGS. 1 and 3, in which the two lids 2, 3 on the end faces of the pressure vessel 1 are retained in the axial direction by the bounding frame 10, and in particular by its end pieces 11, 12. In this way the axial pressure forces acting upon the lids 2, 3 are dissipated over the bounding frame, away from the cylindrical wall of the pressure vessel 1, and cancel each other out.

At the beginning or the end of a treatment cycle the bounding frame 10 can simply be slid downwards over the stands 5, as a result of which the lids 2 and/or 3 can be opened (see FIG. 2).

As can be seen clearly in FIGS. 4 and 5, the lid 3 comprises a cylindrical wall part 15, which in the closed position extends in the axial direction along an inner circumferential wall 16 of the pressure vessel 1. The cylindrical wall part 15 is provided with a circumferential groove, in which a sealing ring 17 is accommodated. The cylindrical wall part 15 with the sealing ring 17 can slide slightly in the axial direction of the pressure vessel 1 along the inner circumferential wall 16, without a leak occurring in the process. This axial movement facility makes it possible to absorb axial elongation of the bounding frame, which can occur during a treatment cycle. Elongation in the bounding frame occurs through the fact that the lids are pressed very forcefully against the end pieces of the bounding frame, under the influence of the high pressure in the pressure vessel. The elongation and the axial movement of the lids 2, 3 in this case are partly a function of the length of the pressure vessel 1 and the bounding frame 10 respectively. Through the axial freedom of the lids 2, 3, the cylindrical wall of the pressure vessel 1 remains free from axial load.

The lids 2, 3 are provided with a holding part, which is, for example, formed by a flange 19 extending outside the pressure vessel 1. The holding part is intended to permit removal of the cylindrical wall part 15 in the axial direction from the pressure vessel 1 if the bounding frame 10 is slid away.

In the embodiment illustrated the bounding frame 10 is composed of two arch-shaped parts 20, 21 and two straight parts 22, 23. This means that bending moments in the bounding frame 10 are prevented, with the result that the weight can be lower. Two substantially semi-cylindrical retaining pieces 25, 26, which can be connected to the arch-shaped parts 20, 21 respectively, and in the closed position rest against the lids 2, 3, are further advantageously provided.

The semi-cylindrical retaining pieces 25, 26 are formed here by aluminium or steel plates placed at a distance from each other. This has proved to give sufficient strength and saves weight. In a variant the retaining pieces are of a solid design and/or are made of a different material. It is also possible to use composite plates, which are either glued directly to each other or connected to each other with foam sheets between them.

The pipe system 7 opens into the lid 3. The feed pipe here is enclosed by the discharge pipe. In order to permit sliding of the bounding frame 10 over the pressure vessel 1, a slotted opening 30 is provided in the frame 10, and in particular in the corresponding retaining piece 26.

The lids 2, 3 in the closed position are supported over a large part of their outer surface against the bounding frame 10. This means that the lids 2, 3 can advantageously be made of a relatively thin-walled design, or of a relatively weak material. The thickness of the lid can in this case, for example, be made equal to the unsupported width of the lid. The cylindrical wall part 15 of the lid is, for example, of a partially hollow design. The lid can be made of, for example, stainless steel or a composite material.

The bounding frame 10 can, for example, be made of steel, for example of steel plates or wound steel strips. Further weight reduction can be achieved by making the bounding frame 10 of composite material, in particular of fibre-reinforced material. More particularly, the bounding frame 10 is made of wound fibre-reinforced material, for example of plastic reinforced with wound glassfibre or carbon fibre. The fibres in this case extend substantially in the circumferential direction of the bounding frame 10.

The cylindrical circumferential wall of the pressure vessel 1 is preferably made of a composite material that on the inside is coated with a layer of material, for example stainless steel, which is resistant to the effect of the treatment medium used. The composite in this case comprises in particular unidirectionally circumferentially wound fibres.

The device is preferably used for dyeing pieces of textile substrate with a fluid under high pressure that contains dye particles. In this case the pipe system 7 is connected to feed means for feeding in this fluid containing dye particles. The fluid in this case is advantageously brought to a supercritical or near critical state, in which the dye particles are dissolved. The supercritical or near critical fluid used can be, inter alia, CO₂, N₂O, lower alkanes and mixtures of the above. Examples of lower alkanes are ethane and propane. The dyeing conditions of the dyeing process according to the invention are selected on the basis of the textile substrate to be dyed and also the dyestuff used. In general, the temperature lies in the range 20-220° C., preferably 90-150° C. The pressure applied during the dyeing operation must be at least so high that the fluid is in the supercritical or near critical state at the prevailing temperature. The pressure usually lies in the range 5×10⁶-5×10⁷ pascal (50-500 bar), more particularly between 2×10⁷-3×10⁷ pascal (200 and 300 bar). As heating system, a heat exchanger can be accommodated in the pipe system 7.

The method for refining a substrate with the device shown is, for example, as follows.

Pieces of textile substrate are placed in the pressure vessel 1 by way of the feed aperture 4. The lids 2 and 3 are subsequently put on, and the pressure vessel 1 and the bounding frame 10 are slid into each other. The lids 2, 3 are now retained in the axial direction, and the pressure vessel 1 can, by way of the pipe system 7, be placed and held under high pressure for a desired cycle time of, for example, several hours by feeding in treatment medium under high pressure. On completion of the cycle time, the bounding frame 10 is lowered, and lid 2 or 3 removed, after which the treated product can be removed from the pressure vessel 1.

Many variants are possible, apart from the embodiment illustrated. For instance, the pressure vessel and bounding frame can be set up either vertically or horizontally. Instead of moving the bounding frame, the pressure vessel can also be removed from it. The mutual direction of movement can be either horizontal or vertical. The feed and discharge pipes of the pipe system can also be connected individually to the lids, or can open into the pressure vessel at another point. The bounding frame and/or the lid can be of a different shape, in which case the surfaces resting against each other can be given, for example, a profiled shape, so long as this does not stand in the way of said surfaces being capable of sliding relative to each other.

In addition to the application of dyeing pieces of a textile substrate, the device can also advantageously be used for treating other kinds of substrate or for refining a substrate in another way, for example washing the substrate. Examples of articles that can suitably be refined with the device and method of the invention include fabrics such as woven and non-woven fabrics formed from materials such as cotton, wool, silk, leather, rayon, polyester, acetate, fiberglass, furs, etc. These fabrics may have been formed into items such as clothing, work gloves, rags, leather goods (e.g. handbags and brief cases), etc. The present device and method may also be used to refine, in particular wash, clean or degrease, non-fabric articles such as semiconductors, micro electromechanical devices, opto electronics, fiber optics, and machined or fabricated metal parts. Furthermore food stuffs and polluted ground may be treated with the device and method according to the present invention.

According to the invention, a user-friendly, efficiently working device is therefore provided, which device can be of a lightweight construction, and in particular has proved to be extremely reliable as regards the sealing effect during refining treatments of pieces of textile substrate under very high pressure.

1-16. (canceled)

17. Device for the piece-wise or batch-wise refining of pieces of a substrate with a treatment medium under high pressure, comprising:
a substantially cylindrical pressure vessel, which is provided with a closable feed aperture for placing the pieces of substrate in said pressure vessel;
a pipe system for feeding the treatment medium to and discharging it from said pressure vessel under high pressure during treatment;
wherein
said cylindrical pressure vessel is provided on at least one of its two end faces with an aperture that can be closed by a lid, which aperture forms said feed aperture
said device comprises retaining means for keeping said lid in place in a sealing manner during treatment,
and said retaining means comprise a bounding frame that is circumferentially closed, with two interconnected end pieces situated at a distance from each other, which end pieces in a closed position can be slid over said pressure vessel and thereby retain said end faces of said pressure vessel in its axial direction.

18. Device according to claim 17, in which said lid comprises a cylindrical wall part that in a position closing said feed aperture extends in said axial direction along an inner circumferential wall of said pressure vessel,
in which at least one sealing ring is provided between said cylindrical wall part and said inner circumferential wall of said pressure vessel, and
in which said sealing ring permits a slide of said lid in said axial direction relative to said inner circumferential wall of said pressure vessel.

19. Device according to claim 17, in which said lid is provided with a holding part, for the purpose of removing said cylindrical wall part from said pressure vessel in said axial direction.

20. Device according to claim 17, in which said bounding frame comprises two straight and two arch-shaped parts.

21. Device according to claim 20, in which two substantially semi-cylindrical retaining pieces, which in said closed position lie between said arch-shaped parts of said bounding frame and said end faces of said pressure vessel, are provided.

22. Device according to claim 17, in which said pipe system opens into said lid.

23. Device according to claim 22, in which a slotted opening is provided in said bounding frame, for the accommodation in a sliding manner in said opening of a part of said pipe system opening into said lid.

24. Device according to claim 17, in which said two end faces of the pressure vessel are provided with feed apertures that are closable by lids.

25. Device according to claim 17, in which said bounding frame is made of composite material, in particular of fibre-reinforced material.

26. Device according to claim 25, in which said bounding frame is made of wound fibre-reinforced material, in particular of wound glassfibre-reinforced plastic.

27. Device according to claim 17, in which the pipe system connects to feed means for feeding in supercritical or near critical fluid.

28. Device for the piece-wise or batch-wise refining of pieces of textile substrate, according to claim 17.

29. Method for the piece-wise or batch-wise refining of pieces of a substrate with a treatment medium under high pressure with a device according to claim 17, comprising the following steps:
placing one or more pieces of said substrate in said pressure vessel;
closing said feed aperture by putting on said lid;
sliding said pressure vessel and said bounding frame into each other;
feeding said treatment medium to said pressure vessel at high pressure for a desired cycle time;
after completion of said cycle time sliding said pressure vessel and the bounding frame out of each other and opening said lid; and
removing said refined substrate from said pressure vessel.

30. Method for the piece-wise or batch-wise refining of pieces of a textile substrate according to claim 29, comprising the step:
placing one or more pieces of said textile substrate in said pressure vessel.

31. Method according to claim 29, in which said treatment medium comprises CO₂, N₂O, lower alkanes such as ethane and propane and mixtures thereof, in particular in a near critical or supercritical state.

32. Use of a device according to claim 17, for the piece-wise or batch-wise refining of pieces of textile substrate.
